(19) United States
(12) Patent Application Publication
(10) Pub. No.: US 2005/0053213 A1
(43) Pub. Date: Mar. 10, 2005

(54) Local number provisioning system and method

(76) Inventor: Jim Giannoit, San Clemente, CA (US)

Correspondence Address: Joseph E. Levi, Zimmerman & Levi, LLP, 226 St. Paul Street, Westfield, NJ, 07090, US

(21) Appl. No.: 10/655,880

(22) Filed: Sep. 6, 2003

(51) Int. Cl. H04M 3/42; H04M 7/00

(52) U.S. Cl. 379/201.12; 379/221.13

(57) ABSTRACT

A method and switching system that provisions to subscribers a geographically-specific telephone number. The geographically-specific telephone number is useable by the public switched network (PSTN) and translated by the switching system to connect the call to the subscriber that may be situated outside the geographic local associated with the geographically-specific telephone number. To complete a call, the switching system translates the geographically-specific telephone number to a global customer address of the system. The global customer address is sent to the local exchange carrier (LEC) or internet service provider (ISP) associated with the geographical local of the customer using the global customer address. The switching system also provides call identification capability when the subscriber makes a call to a user on the PSTN.

### FIELD OF THE INVENTION

The present invention pertains to telephony networks and, more particularly, to a method and system for assigning its subscribers a geographically-specific telephone number that is useable by the public switched network (PSTN) to a subscriber that is situated outside the specific geographic region.

### BACKGROUND OF THE INVENTION

Typically, phone numbers given to a subscriber or customer of telephone network, such as the PSTN, are geographically-specific requiring an area code, exchange and phone number. When a subscriber moves from one location to another, oftentimes a new phone number is required. Having to change a phone can be costly for businesses and customers (especially those that have had their phone numbers for many years) and often results lost revenues and increased overhead costs. Furthermore, it is often desirable for an individual or businesses to have and maintain a local phone number associated with a particular geographic region even though that individual/business doesn't reside in that particular region. In this way, a geographically distant individual/business can maintain a local presence in the region and also reduce communications costs for those desiring to call.

In view of the foregoing, there is a continuing need for a method and system that provisions geographically-specific numbers to geographically distant customers.

### SUMMARY

A method and system is provided for provisioning a local telephone number to a customer located outside the local calling region so that remote callers can communicate with the customer via the local telephone number regardless of the physical location of the customer.

During a channel opening process to complete a call, the system translates the geographically-specific telephone number to a global customer address of the system. The global customer address is sent to the local exchange carrier (LEC) associated with the geographical local of the customer using the global customer address.

The system also sends the subscriber's call identification during an outbound call to a person called at a destination local exchange carrier (LEC).

### BRIEF DESCRIPTION OF THE DRAWINGS

FIG. 1 illustrates a general system diagram with the N2G switching system 20 interfaced with the public switch telephone network and Internet service providers.

FIG. 2 illustrates a general signaling flowchart in a channel opening process that translates an E.164 standard phone number of a local LEC for use at a destination LEC.

FIG. 3 illustrates a general signaling flowchart in a channel opening process that translates an E.164 standard phone number of a local LEC to a softphone.

FIG. 4 illustrates a general signaling flowchart in a channel opening process for a N2G customer with translated caller identification for the outbound call.

### DETAILED DESCRIPTION OF THE INVENTION

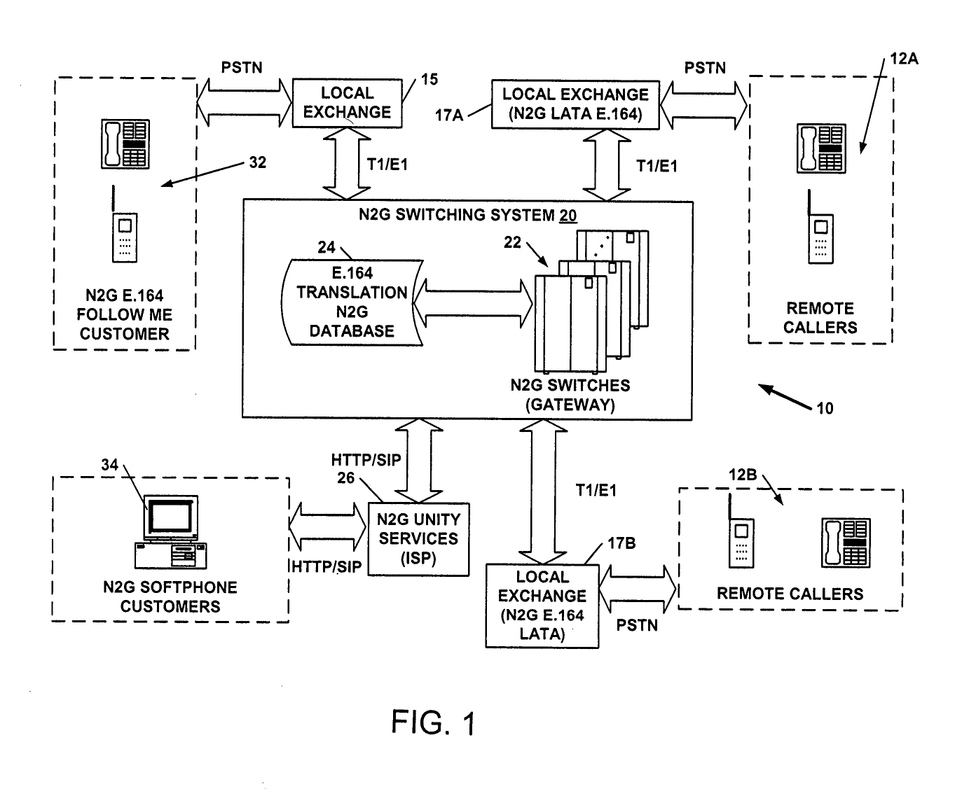

Referring now to FIG. 1, there is shown a switching system 20 of the present invention that provides geographically-specific phone numbers according to the E.164 standard, to voice communications customers regardless of their geographical location on the earth's continents. The geographically-specific (local) phone numbers are acquired by the entity operating the N2G switching system 20 according to standard procedures provided for in that specific region. The entity may allow a customer to select a particular local phone number (even though the customer is not located in the corresponding geographic region) so that the customer can establish a communications presence in that particular region. The N2G switching system 20 is a global switching system comprising at least one switch 22 and an E.164 translation database 24 so that a remote caller can contact the customer anywhere in the world using the customer's geographically-specific phone number.

The N2G switching system 20 communicates with the local exchange carriers (LEC) 15, 17A and 17B of the public switched telephone network (PSTN) and Internet service providers (ISP) 26. In the exemplary embodiment, the N2G switching system 20 communicates with the LECs 15, 17A and 17B via T1 carriers. Additionally, the N2G switching system 20 communicates with the ISPs 26 via either hypertext transport protocol (HTTP) or Session Initiation Protocol (SIP). In an exemplary embodiment, switching system 20 includes a plurality of geographically dispersed switches 22 that are in communications with each other via the Internet. In this way, a call received from a remote caller 12A, 12B via LEC 17A,17B, respectively, in a first geographic region is routed by switches 22 over the Internet to reach the LEC 15 or ISP 26 associated with customer 32, 34, respectively, in a second geographic region. Also, while the descriptions above and below refer to local exchange carriers, switching system 20 may also communicate with other entities such as, by way of non-limiting example, competitive local exchange carriers and any other entities that service customers of communications services.

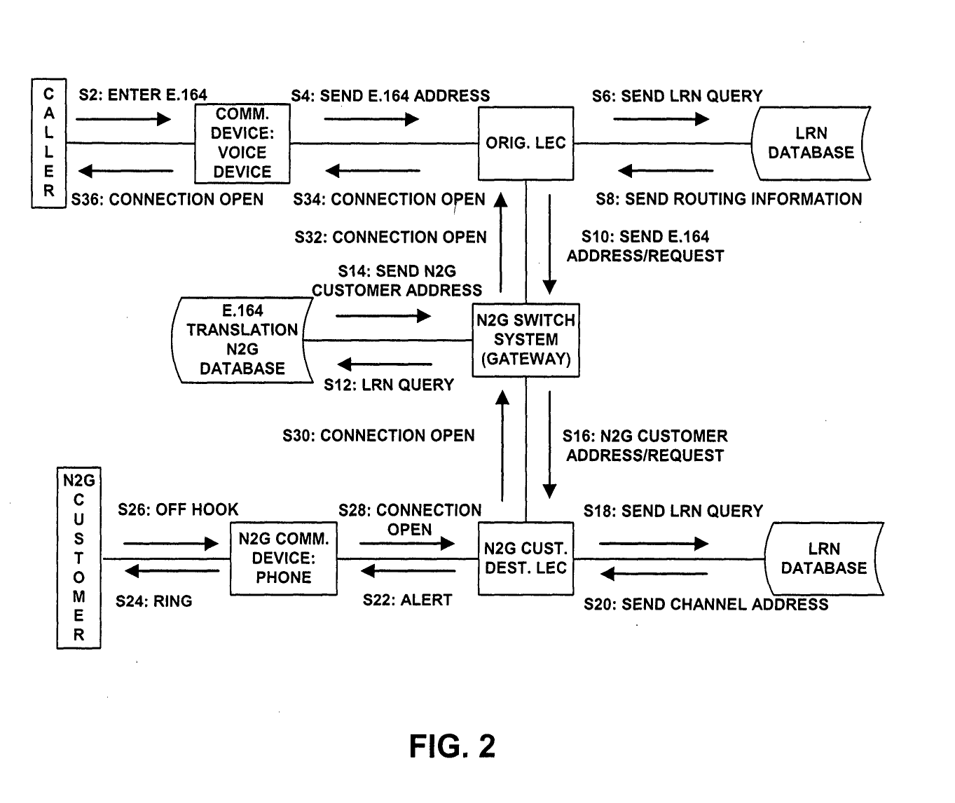

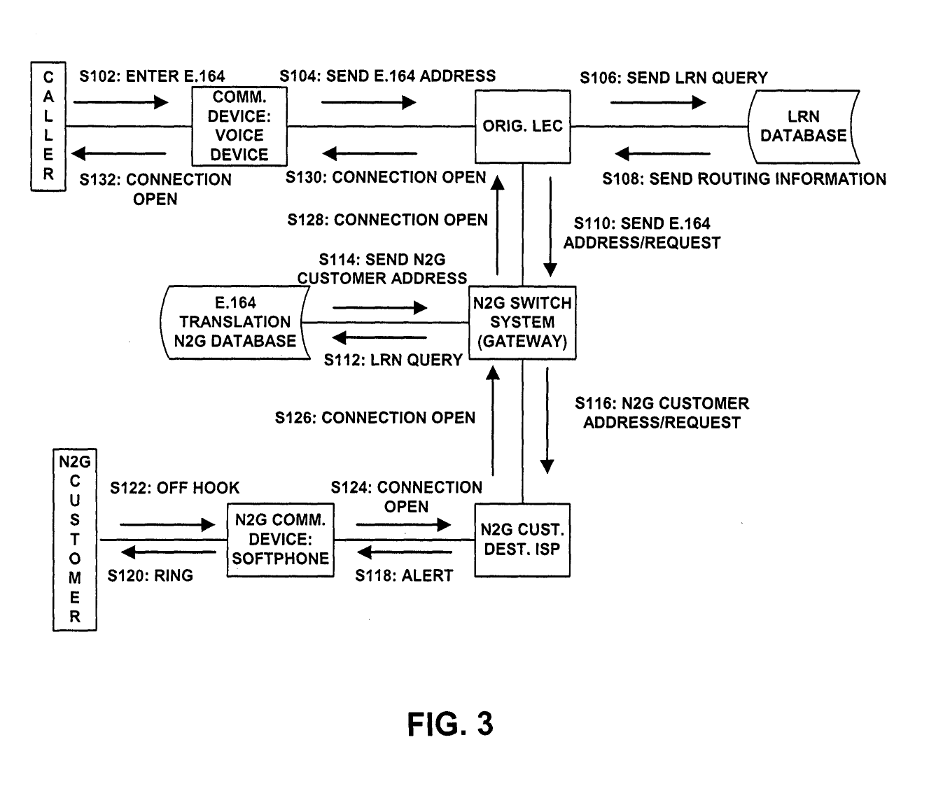

Typically, a set of local (geographically-specific) E.164 telephone numbers are maintained in a line information (LRN) database (FIGS. 2 and 3) at each LEC 15, 17A, 17B. A subset of these local (geographically-specific) phone numbers belong to the N2G company to provide voice communications and/or other communications via the N2G switching system 20. In the exemplary embodiment, the N2G company acquires a subset of local (geographically-specific) phone numbers from each of the LECs. The acquired subsets of local phone numbers will hereinafter be referred to as “N2G phone numbers.” When a subscriber or customer subscribes to the N2G switching system 20, they select or may be assigned a N2G phone number. While the N2G phone number is a geographically-specific number, the N2G switching system 20 allows its subscribers or customers to be situated outside of the geographical location associated with the geographically-specific number and still receive/make calls.

In brief, to complete a call to a subscriber or customer 32 or 34 on the N2G switching system 20, a caller 12A or 12B dials the N2G phone number associated with the subscriber or customer 32 or 34 that is connected to a respective one of the LECs 15, 17A, and 17B of the PSTN. A respective one of the LECs 15, 17A, and 17B receives the N2G phone number and interprets the N2G phone number as being a call for the N2G switching system 20. Accordingly, the LEC 15, 17A, and 17B relays the call to the N2G switching system 20.

Referring now to the N2G switching system 20, the at least one switch 22 communicates with the LECs 15, 17A and 17B and/or ISPs with voice-over Internet protocol (VoIP), PRI, or Signaling System 7 (SS7) links to carry traffic from the LECs15, 17A and 17B and/or ISP 26. The subscriber or customer communicates with the N2G switching system 20 via a communication device. In the exemplary embodiment, the N2G switching system 20 supports conventional land-line telephones using a plain old telephone service (POTS) line connections and cellular or mobile phones 32 (that are routed over cellular networks to LECs 15, 17A, 17B according to known techniques). Moreover, the N2G switching system 20 supports softphones 34, wherein a softphone 34 is an Internet protocol (IP) based phone adapted to communicate to N2G switching system 20 via an ISP connection.

When a remote caller enters one of the E.164 local numbers, the call is routed by a local LEC 17A and 17B (such local LEC is hereinafter referred to as an origination LEC) to the N2G switching system 20. Thereafter, the N2G switching system 20 establishes a connection between the origination LEC 17A and 17B and the local destination LEC 15 supporting the N2G customer device 32. Alternately, if the N2G customer uses a softphone 34 the N2G switching system 20 establishes a connection between the originating LEC 17A/17B and the destination ISP 26 that communicates with softphone 34 (via, for example, a VoIP connection. In either case, the N2G switching system 20 performs the necessary address and/or protocol translations so that remote callers 12A/12B can reach customer 32/34 by dialing a local N2G phone number and have voice communications with the corresponding customer even though the customer is not located in the local calling region. Furthermore, because the N2G switching system 20 may include geographically dispersed switches 22 connected via the Internet, system 20 can receive a call from remote caller 12A/12B to a local N2G phone number and seamlessly route that call to customer 32/34 located anywhere in the world.

The channel opening processes using E.164 local numbers through the N2G switching system 20 is described in FIGS. 2-4.

Referring now to FIG. 2, a general signaling flowchart in a channel opening process that translates an E.164 standard phone number of a local LEC for use at a destination LEC is illustrated. The channel opening process begins at Step S2 where a caller enters the E.164 number via a communication device 12A or 12B (FIG. 1), such as a (land-line, cellular or mobile) telephone or other voice device. Step S2 is followed by Step S4 where the device sends the E.164 address information to the local LEC, hereinafter referred to as the origination LEC. Step S4 is followed by Step S6 where the origination LEC performs a query to determine the routing information from the local routing number (LRN) database, based on the E.164 address information. Step S6 is followed by Step S8 where the origination LEC receives the routing information. Step S8 is followed by Step S10 where the origination LEC sends the E.164 address with a request to the N2G switching system 20. Step S10 is followed by Step S12 where the N2G switching system 20 performs a query for the local routing number and performs a translation of the local routing number via an E.164 translation database 24. Step S12 is followed by Step S14 where the switch 22 of the N2G switching system 20 receives the N2G customer address. Thereafter, Step S14 is followed by Step S16 where the N2G switching system 20 sends the N2G customer's address and request to the N2G customer's LEC or destination LEC. Step S16 is followed by Step S18 where the destination LEC sends a LRN query to its LRN database. Step S18 is followed by Step S20 where the LRN database sends the channel address to the appropriate outbound trunk group(s) based on a predetermined routing matrix that is established by the customer as well as N2G the service provider. The routing consideration in the case of the customer is governed by predetermined connectivity setting(s) that are in place and controlled by traditional DTMF set on a phone device or through a web interface which can be accessed using a browser. Once the parameters are in place depending on the type of call i.e., Internet based or PSTN the N2G switch will match up the destination that is governed by an internal least cost routing (LCR) table. If the call is to an IP device it will be sent out to the appropriate ISP and if it is to a traditional phone device it is passed to the PSTN. When passing a call through the PSTN certain considerations such as quality of service to a specific destination by call type i.e., International or domestic the availability of fiber and cost determine which circuits are to pass the call. Once this determination is made the call is passed to the destination LEC. Step S20 is followed by Step S22 where an alert (ringing signal) is sent to the customer's communication device (e.g., phone) where such device will ring or produce some alert of an incoming call.

If the customer answers the phone, an off-hook condition is sensed at Step S26. On the other hand, the phone may be equipped with an answering machine. Thus, the answering machine may create the off-hook condition. In either case, when the off-hook condition is sensed, an open connection is created at Step S28 between the phone and the destination LEC. Step S28 is followed by Step S30 where an open connection is created between the destination LEC and the N2G switching system 20. Step S30 is followed by Step S32 where an open connection is created between the origination LEC and the N2G switching system 20. Step S32 is followed by Step S34 where an open connection is created between the origination LEC and the caller's phone or device. Step S34 is followed by Step S36 where an open connection is created.

As can be readily seen, the N2G switching system 20 allows customer 32/34 to establish a regional communications presence by having a local E.164 phone number even if customer 32/34 is physically located in a geographically distant region. Furthermore, if the customer's residence changes from one geographical region to another, the customer can still maintain the same local E.164 number so that communications with the customer by remote callers remains uninterrupted.

Referring now to FIG. 3, a general signaling flowchart in a channel opening process that translates an E.164 standard phone number of a local LEC to a softphone using VoIP is shown. The channel opening process begins at Step S102 where the caller enters the E.164 number via the caller's device such as a voice device. Step S102 is followed by Step S104 where the caller's device sends the E.164 address information to the caller's local LEC or origination LEC. Step S104 is followed by Step S106 where the origination LEC performs a query to determine the local routing information from the local routing number (LRN) database. Step S106 is followed by Step S108 where the origination LEC receives the routing information. Step S108 is followed by Step S110 where the origination LEC sends the E.164 address with a request to the N2G switching system 20. Step S110 is followed by Step S112 where the N2G switching system 20 performs a query for the local routing number (LRN). Step S112 is followed by Step S114 where the switch receives the N2G customer address. In this embodiment, the customer address is for a softphone 34 served by an ISP 26. Thereafter, Step S114 is followed by Step S116 where the N2G switching system 20 sends the N2G customer's address and request to the N2G destination internet service provider (ISP). Step S116 is followed by Step S118 where an alert is sent to the N2G customer's soft phone which creates a ringing signal at Step S120 at the softphone.

Step S120 is followed by Step S122 where an off hook signal is created when the N2G customer answers the softphone. Alternately, an answering machine associated with the softphone may create an off hook condition. Thereafter, Steps S124, S126, S128, S130, S132, create open connections between: the softphone and the destination ISP; the N2G switching system 20 and the destination ISP; the N2G switching system and the origination LEC; and the origination LEC and caller's voice device. In an exemplary embodiment, the connection that is established between softphone 34 and ISP 26 is a Voice-over-IP (VoIP) connection as in known in the art.

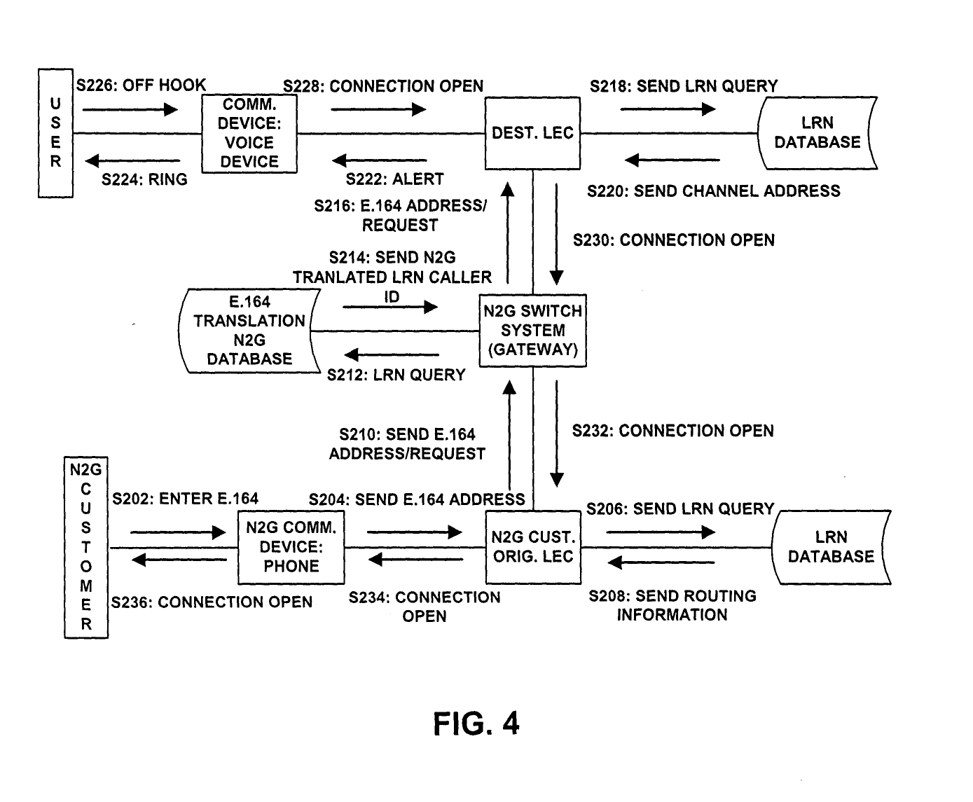

Referring now to FIG. 4, a general signaling flowchart in a channel opening process for a N2G customer originated call with translated caller identification for the outbound call is illustrated. The channel opening process begins at Step S202 where the N2G customer is the caller and enters the E.164 number via a voice device or (land-line, cellular or mobile) telephone 32. Step S202 is followed by Step S204 where the device sends the E.164 address information to the local LEC or origination LEC. Step S204 is followed by Step S206 where the origination LEC performs a query to determine the routing information from the local routing number (LRN) database. Step S206 is followed by Step S208 where the origination LEC receives the routing information. Step S208 is followed by Step S210 where the origination LEC sends the E.164 address with a request to the N2G switching system 20. Step S210 is followed by Step S212 where the N2G switching system 20 performs a query for the local routing number and performs a translation of the local routing number via an E.164 translation database 24 and determines a LRN caller identification. Step S212 is followed by Step S214 where the switch 22 of the N2G switching system 20 receives the N2G translated LRN caller identification.

Thereafter, Step S214 is followed by Step S216 where the N2G switching system 20 sends the E.164 address of the user being called and call request to the user's LEC or destination LEC. Step S216 is followed by Step S218 where the destination LEC sends a LRN query to its LRN database. Step S218 is followed by Step S220 where the LRN database sends the channel address to the destination LEC. Step S220 is followed by Step S222 where an alert (ringing signal) is sent to the user's communication device (phone) 12A or 12B where such device will ring or produce some alert of an incoming call.

If the user answers the phone, an off-hook condition is sensed at Step S226. On the other hand, the phone may be equipped with an answering machine. Thus, the answering machine may create the off-hook condition. In either case, when the off-hook condition is sensed, an open connection is created at Step S228 between the user's communication device (phone) 12A or 12B and the destination LEC. Step S228 is followed by Step S230 where an open connection is created between the destination LEC and the N2G switching system 20. Step S230 is followed by step S232 where an open connection is created between the origination LEC and the N2G switching system. Step S232 is followed by Step S234 where an open connection is created between the origination LEC and the N2G subscriber's phone or device 32. Step S234 is followed by Step S236 where an open connection is created.

Regarding the channel opening process of FIG. 4, if the N2G customer device is a softphone the E.164 address is mapped to a VoIP channel that is established between ISP 26 and customer's softphone 34.

In an exemplary embodiment, in addition to routing voice communications between remote callers to customers, switching system 20 routes other traffic such as, by way of non-limiting example, video, data and multimedia traffic. In another exemplary embodiment, remote callers and customers may communicate using any device including, by way of non-limiting example, PDAs, cellular phones, multimedia devices. Furthermore, in an exemplary embodiment, switching system 20 stores a plurality of communication devices addresses associated with the customer so that switching system 20 can establish a communications link with the customer. These communication device addresses may include, by way of non-limiting example, telephone numbers and IP addresses that correspond to the customer's telephones (land-line, wireless) and computing devices (that function as softphones) via which the customer desires to engage in communications. Upon receiving from a remote caller a request to communicate with the customer at the customer's designated geographically-specific phone number, switching system 20 establishes a communications link with the customer using any/all of the communication device addresses associated with the customer thereby enabling the remote and the customer to communicate.

In an exemplary embodiment, the entity operating switching system 20 provides a customer with a listing of various regions and enables the customer to select a phone number that is local to any of the regions (regardless of the region the particular customer actually resides in). In an exemplary embodiment, switching system 20 includes a web server that provides this listing on a web page accessible via the Internet and, when the customer selects a desired local number from the listing, the entity designates that number as the customers local telephone number. Callers that desire to contact the customer can use the selected local number and switching system 20 will route the call to any number of communication devices (land-line telephone, cellular phone, softphone) designated by the customer regardless of the location. In this way, the customer can establish a local communications presence in any particular region.

Accordingly, a method and system is provided for provisioning a local telephone number to a customer located outside the local calling region so that remote callers can communicate with the customer via the local telephone number regardless of the physical location of the customer.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

1. A method for provisioning a geographically-specific phone number to a customer, comprising the steps of:
providing said customer with a plurality of geographically-specific phone numbers;
receiving from said customer a selected geographically-specific phone number corresponding to a first geographic region wherein said customer is located in a second geographic region;
associating said selected geographically-specific phone number with said customer;
receiving from a remote caller a request to communicate with said customer at said selected geographically-specific phone number;
establishing a communications link with said customer; and
enabling said remote caller and said customer to communicate via said communications link.

2. The method of claim 1, wherein said plurality of geographically-specific phone numbers are E.164 phone numbers.

3. The method of claim 1, wherein said request from said remote caller is received via a PSTN connection

4. The method of claim 1, wherein said communications link is a PSTN connection.

5. The method of claim 1, wherein said communications link is a wireless connection.

6. The method of claim 1, wherein said communications link is an IP connection.

7. The method of claim 1, wherein said communications link is a VoIP connection.

8. The method of claim 1, wherein the step of establishing a communications link includes the steps of:
storing at least one communication device address associated with said customer; and
establishing a link with said customer via said at least one communication device address.

9. The method of claim 8 wherein said at least one communication device address includes at least one selected from the group including a telephone number and an IP address.

10. The method of claim 1, wherein the steps of providing said customer with a plurality of geographically-specific phone numbers and receiving from said customer a selected geographically-specific phone number is performed via the Internet.

11. The method of claim 1, wherein said communications link supports any type of communications selected from the group including voice, data and video.

12. A method for provisioning a geographically-specific phone number to a customer, comprising the steps of:
means for providing said customer with a plurality of geographically-specific phone numbers;
means for receiving from said customer a selected geographically-specific phone number corresponding to a first geographic region wherein said customer is located in a second geographic region;
means for associating said selected geographically-specific phone number with said customer;
means for receiving from a remote caller a request to communicate with said customer at said selected geographically-specific phone number; and
means for establishing a communications link with said customer;
enabling said remote caller and said customer to communicate via said communications link.

13. A system for provisioning a geographically-specific phone number to a customer, comprising the steps of:
a switching system for providing said customer with a plurality of geographically-specific phone numbers and receiving from said customer a selected geographically-specific phone number corresponding to a first geographic region wherein said customer is located in a second geographic region;
a translation database included in said switching system, said translation database associating said selected geographically-specific phone number with at least one communication device address of said customer; and
at least one gateway included in said switching system;
wherein when said switching system receives from a remote caller a request to communicate with said customer at said selected geographically-specific phone number, said switching system establishes a communications link with said customer and enables said remote caller and said customer to communicate via said communications link.

14. The system of claim 13, wherein said plurality of geographically-specific phone numbers are E.164 phone numbers.

15. The system of claim 13, wherein said communications link is selected from a group including a PSTN connection, a wireless connection, an IP connection and a VoIP connection.

16. The system of claim 13 wherein said at least one communication device address includes at least one selected from the group including a telephone number and an IP address.

17. The system of claim 13, wherein the steps of providing said customer with a plurality of geographically-specific phone numbers and receiving from said customer a selected geographically-specific phone number is performed via the Internet.

18. The system of claim 13, wherein said switching system includes a plurality of geographically dispersed gateways and wherein at least one of said geographically dispersed gateways communicates with at least another of said geographically dispersed gateways via the Internet.

19. The system of claim 18, wherein said at least one geographically dispersed gateway is in communications with a carrier servicing said first geographic region and said at least another geographically dispersed gateway is in communications with a carrier servicing said second geographic region.

20. The method of claim 13, wherein said communications link supports any type of communications selected from the group including voice, data and video.
